(19) United States
(12) Patent Application Publication
(10) Pub. No.: US 2025/0292321 A1
(43) Pub. Date: Sep. 18, 2025

(54) BLOCKCHAIN-BASED DATA ASSET CUSTODY AND PLEDGE FINANCING SYSTEM

(71) Applicant: Shanghai data exchange corp, Shanghai (CN)

(72) Inventors: Qifeng TANG, Shanghai (CN); Bin HE, Shanghai (CN)

(73) Assignee: Shanghai data exchange corp, Shanghai (CN)

(21) Appl. No.: 18/929,567

(22) Filed: Oct. 28, 2024

(30) Foreign Application Priority Data
Mar. 18, 2024 (CN) 2024103039308

(51) Int. Cl. G06Q 40/03; G06Q 40/06

(52) U.S. Cl. CPC G06Q 40/03; G06Q 40/06

(57) ABSTRACT

A blockchain-based data asset custody and pledge financing system, including a blockchain subsystem, a data assetization space, and a pledge financing subsystem. The system performs data assetization and data asset custody through the blockchain subsystem and the data assetization space, and then carries out data asset pledge financing through the blockchain subsystem and the pledge financing subsystem. Through full-process intelligent contract permission control and scheduling for data asset assetization, full-process measurable and traceable custody for data asset assetization, and full-link reliable evaluation and credit assessment for data asset pledge, the system ensures security control, authenticity, measurability, traceability, and oversight of data assets. This facilitates secure and efficient pledge financing of data assets, significantly reduces operating costs, meets customers' needs for efficient capital turnover, and provides effective financing services for core data enterprises.

### FIELD OF THE INVENTION

The present disclosure relates to the field of blockchain technology, specifically relates to a blockchain-based data asset custody and pledge financing system.

### BACKGROUND OF THE INVENTION

Data asset pledge financing is a process of data assetization in which data assets are converted into the economic value. As a method of data assetization, pledge financing allows data-owning enterprises or individuals to use their data assets as collateral to seek financial support from financial institutions or third-party financing platforms. Unlike traditional pledge financing, the ownership of the data assets is not transferred during the pledge process. This financing method relies on various technologies to facilitate its operation and management, including blockchain technology, big data technology, data asset evaluation technology, and data security management technology. These technologies provide decentralized, secure and trustworthy data storage and transmission methods for data asset custody and pledge financing, as well as efficient data processing, analysis, and evaluation capabilities.

However, despite the strong support these technologies provide for data asset custody and pledge financing, there are still some shortcomings and challenges:
1. Ensuring the security and controllability of the data assets has been challenging. Data asset custody and pledge financing involves a large amount of sensitive data, such as corporate business data and personal information. It is difficult to ensure the security and controllability of data assets during transmission, storage, and usage.
2. Data assets are difficult to measure. Although technologies like blockchain and big data have seen some applications and development, it remains difficult to accurately measure data assets in the area of data asset custody and pledge financing.
3. Data assets are not traceable. Existing technologies lack traceability in data circulation, making it difficult for enterprises to effectively monitor the use and sharing of data assets, thereby increasing compliance risk and data leakage risk.
4. Regulating data presents a challenge. Existing technologies lack effective regulatory measures, making it difficult for enterprises to detect and prevent potential data risks and non-compliant behaviors in a timely manner.

### SUMMARY OF THE INVENTION

A blockchain-based data asset custody and pledge financing system, including a blockchain subsystem, a data assetization space, and a pledge financing subsystem. The blockchain subsystem is used to provide full-process on-chain services for data resources, data products, and data asset circulation and transactions, along with query and control services. The data assetization space communicatively connected to the blockchain subsystem for providing data assetization services and infrastructure. The pledge financing subsystem is communicatively connected to the blockchain subsystem for providing services related to data asset pledge financing. The system performs data assetization and data asset custody through the blockchain subsystem and the data assetization space, and carries out data asset pledge financing through the blockchain subsystem and the pledge financing subsystem.

In one embodiment of the present disclosure, the blockchain subsystem includes: a chain account module for maintaining a blockchain account, an account data identity module for maintaining an account data identity corresponding to the blockchain account, an account transaction depository module for recording evidence of account transactions generated by the data assetization space, an account transaction certificate module for recording blockchain data transaction certificates generated by the data assetization space, an account asset certificate module for recording data asset certificates generated by the pledge financing subsystem, a permission smart contract module for deploying and executing a corresponding permission smart contract based on the account data identity maintained by the account data identity module, and an operation smart contract module for deploying and executing a corresponding operation smart contract based on the account data identity maintained by the account data identity module.

In one embodiment of the present disclosure, the data assetization space includes: a data resource authorization operation center, a data resource catalog subsystem, a data product transaction subsystem, a data circulation service subsystem, a data transaction certificate subsystem, an endogenous security gateway channel, and a data trusted circulation framework. The endogenous security gateway channel is used to access the data that needs to be circulated and traded to the data resource authorization operation center. The data resource authorization operation center is communicatively connected with the chain account module for blockchain identity management, data authorization operation, and data authorization custody. The data resource catalog subsystem is used to manage data that needs to be circulated and traded after being authorized by the data resource authorization operation center; the data product transaction subsystem is used to conduct a transaction operation of a data product based on a configured smart contract, and upload the entire transaction process to the blockchain through the smart contract. The data circulation service subsystem is used to share data that needs to be circulated in the data resource catalog subsystem. The data transaction certificate subsystem is used to generate a blockchain data transaction certificate through the configured smart contract after the data product transaction subsystem completes a data product transaction. The data assetization space also delivers data after completing the data product transaction through the data circulation service subsystem, the data trusted circulation framework, and the endogenous security gateway channel.

In one embodiment of the present disclosure, the method for data assetization through the blockchain subsystem and data assetization space includes: a data provider business system performing blockchain identity management through the data resource authorization operation center, where the blockchain identity management includes: one or more operations of blockchain account registration, login, and authentication; the data provider business system accessing the data required for circulation and transaction through the endogenous security gateway channel to the data resource authorization operation center, for the purpose of classifying, categorizing, and authorizing the accessed data directory; after being authorized by the data resource authorization operation center, the data provider business system managing the data that needs to be circulated and traded through the data resource catalog subsystem, registering the data to be traded through the data resource catalog subsystem to data product transaction subsystem, and sharing the data to be circulated through the data circulation service subsystem; the data provider business system performing a data product transaction operation based on the configured smart contract through the data product transaction subsystem, uploading the entire transaction process to the blockchain through the smart contract, and generating an account transaction certificate of the data provider business system; after the data product transaction subsystem completing the data product transaction, the data provider business system generating a blockchain data transaction certificate based on the smart contract through the data transaction certificate subsystem; and after the data product transaction subsystem completing the data product transaction, the data provider business system delivering data to the data demander business system through the data trusted circulation framework and the endogenous security gateway channel;

In one embodiment of the present disclosure, the method for data asset custody through the blockchain and data assetization space includes: a data provider business system, performing blockchain identity management through the data resource authorization operation center, where the blockchain identity management includes: one or more operations of blockchain account registration, login, and authentication; the data provider business system, performing data authorization operation and data authorization custody through the data resource authorization operation center, and registering the custody information to the corresponding blockchain account, and account digital identity in the blockchain subsystem through the data resource authorization operation center after authorization; after completing the registration of the blockchain account and the digital identity, simultaneously deploying the permission smart contract and the operation smart contract in the blockchain subsystem; executing the deployed permission smart contract and operation smart contract, and executing the data assetization service custody account permissions and operational permissions through the data product transaction subsystem, the data circulation service subsystem, the data transaction certificate subsystem, and the date trusted circulation framework.

In one embodiment, the types of data authorization custody include: authorization operation custody, data resource custody, data product custody, data product transaction custody, data transaction service custody, data transaction certificate custody, data transaction depository custody, and data asset certificate custody.

In another embodiment, the pledge financing subsystem includes: an asset account module, a data asset pledge application module, a data asset pledge evaluation module, a data asset pledge credit module, a data asset certificate generation module, a data asset certificate pledge module, and a data asset pledge management module. The asset account module is for performing blockchain identity management. The data asset pledge application module is used to apply for the pledge of some or all of the selected data assets. The data asset pledge evaluation module is used to assist an evaluation agency to evaluate selected data assets based on blockchain account transaction record data stored in the blockchain subsystem. The data asset pledge credit module is used to assist a credit agency to query and verify selected data assets based on blockchain account transaction evidence recorded in the blockchain subsystem. The data asset certificate generation module is used to generate a data asset certificate after the evaluation and verification have been completed, and record it in the account asset certificate module of the blockchain. The data asset certificate pledge module is used to pledge data asset certificates. The data asset pledge management module is used to perform a pledge control process based on a data asset certificate smart contract deployed in the blockchain subsystem.

In yet another embodiment, the method for data asset pledge financing through the blockchain subsystem and the pledge financing subsystem includes: a data provider business system performing one or more operations of blockchain account registration, login, and authentication through the asset account module; the data provider business system querying the account transaction certificate of the corresponding account digital identity recorded in the blockchain subsystem through the data asset pledge application module, selecting some or all of the data assets for pledge application, and automatically registering the information of the data asset pledge application with the permission smart contract of the account digital identity deployed in the blockchain subsystem for verifying the custody privileges of the corresponding blockchain account; after passing the custody privilege verification, the evaluation agency evaluating the data assets selected by the data provider business system based on the transaction deposit data of the blockchain account through the data asset pledge evaluation module; the credit agency querying and verifying the data assets selected by the data provider business system based on the transaction certificate of the blockchain account through the data asset pledge credit module; after passing the evaluation and verification, the data provider business system generating a data asset certificate through the data asset certificate generation module and recording it to the account asset certificate module of the blockchain subsystem; after generating the data asset certificate, pledging the data asset certificate through the data asset certificate pledge module, and simultaneously deploying the corresponding data asset certificate smart contract from the operation smart contract in the blockchain subsystem; after completing the pledge of data asset certificate and the deployment of data asset certificate smart contract, automatically starting and executing the pledge control process for the corresponding data asset certificate smart contract through the data asset pledge management module.

In another embodiment, the data asset certificate smart contract includes: a pledge financing product smart contract for binding some or all of the data products selected by the data provider business system, a pledge financing risk control smart contract for managing and controlling the smart contract of the entire data assetization process, a pledge financing transaction smart contract for data resource authorization operation, full-process smart contract custody of data products and security control, and a pledge financing settlement smart contract for configuring the settlement route of the data product settlement smart contract, which is automatically executed according to the fund provider's configuration.

In one embodiment, the data trusted circulation framework uses data encryption and security technologies for communication.

As described above, the blockchain-based data asset custody and pledge financing system has the following beneficial effects: the blockchain-based data asset custody and pledge financing system includes a blockchain subsystem, a data assetization space, and a pledge financing subsystem. The system performs data assetization and data asset custody through the blockchain subsystem and the data assetization space, and then carries out data asset pledge financing through the blockchain subsystem and the pledge financing subsystem. Through full-process intelligent contract permission control and scheduling for data asset assetization, full-process measurable and traceable custody for data asset assetization, and full-link reliable evaluation and credit assessment for data asset pledge, the system ensures security control, authenticity, measurability, traceability, and oversight of data assets. This facilitates secure and efficient pledge financing of data assets, significantly reduces operating costs, meets customers' needs for efficient capital turnover, and provides effective financing services for core data enterprises.

### BRIEF DESCRIPTION OF DRAWINGS

FIG. 1 shows a schematic block diagram of a blockchain-based data asset custody and pledge financing system according to one embodiment of the present disclosure;

FIG. 2 shows a schematic block diagram of a blockchain-based data asset custody and pledge financing system according to one embodiment of the present disclosure;

FIG. 3 shows a schematic flow diagram of a data assetization process according to one embodiment of the present disclosure;

FIG. 4 shows a schematic diagram of custody types in the authorization operation center according to one embodiment of the present disclosure; and

FIG. 5 shows a schematic flow diagram of a data asset pledge financing process according to one embodiment of the present disclosure.

### DETAILED DESCRIPTION

The specific embodiments are described below to illustrate the implementation of the present disclosure, and those skilled in the art can easily understand other advantages and effects of the present disclosure from the content disclosed in this specification. The present disclosure can also be implemented or applied in other specific embodiments. The details provided in this description can be modified or altered in various ways based on different perspectives and applications without departing from the spirit of the present disclosure. It should be noted that the embodiments and features of the embodiments in the present disclosure can be combined with each other as long as there is no conflict.

It should be noted that in the following description, reference is made to the accompanying drawings, which illustrate several embodiments of the present disclosure. It should be understood that other embodiments may also be used, and mechanical, structural, electrical, and operational changes can be made without departing from the spirit and scope of the present disclosure The following detailed description should not be considered limiting, and the scope of the embodiments of the present application is only limited by the patent claims published. The terms used herein are only intended to describe specific implementations, rather than to limit the scope of this application. Terms related to space, such as “up”, “down”, “left”, “right”, “below”, “under”, “lower”, “above”, and “upper”, can be used in the text to illustrate the relationship between one component or feature and another component or feature shown in the drawings.

In the entire specification, when referring to a portion being “connected” to another portion, this includes not only “direct connections” but also “indirect connections” where other elements are interposed between them. Additionally, when a certain part is said to “include” a certain component, it does not exclude other components unless explicitly stated otherwise. It means that other components may also be included.

The terms “first,” “second,” “third,” and so on mentioned herein are used to describe various parts, components, regions, layers, and/or sections, but are not limited to these terms. These terms are used solely to distinguish one part, component, region, layer, or section from others. Therefore, the term “first part,” “component,” “region,” “layer,” or “section” described below may also refer to a “second part,” “component,” “region,” “layer,” or “section” within the scope of the present invention.

Furthermore, in this article, the singular forms “a,” “an,” and “the” include plural referents, unless otherwise indicated by the context. It should be further understood that the terms “including” and “comprising” indicate the presence of the described features, operations, elements, components, items, types, and/or groups, but do not exclude the presence, occurrence, or addition of one or more other features, operations, elements, components, items, types, and/or groups. The terms “or” and “and/or” used here are interpreted as inclusive, meaning any one or any combination. Therefore, “A, B, or C” or “A, B and/or C” means “any one or more of the following: A; B; C; A and B; A and C; B and C; A, B and C”. A; B; C; A and B; A and C; B and C; A, B and C”. Only when the combination of elements, functions, or operations inherently repel each other in some way, will the exceptions to this definition be allowed.

A blockchain-based data asset custody and pledge financing system, including a blockchain subsystem, a data assetization space, and a pledge financing subsystem. The system performs data assetization and data asset custody through the blockchain and the data assetization space, and then carries out data asset pledge financing through the blockchain and the pledge financing subsystem. The system ensures security control, authenticity, measurability, traceability, and oversight of data assets through full-process intelligent contract permission control and scheduling for data asset assetization, full-process measurable and traceable custody for data asset assetization, and full-link reliable evaluation and credit assessment for data asset pledge. This facilitates secure and efficient pledge financing of data assets, significantly reduces operating costs, meets customers' needs for efficient capital turnover, and provides effective financing services for core data enterprises.

The following detailed description of the embodiments of the present disclosure is provided with reference to the accompanying drawings, so that those skilled in the relevant technical field can easily implement the present disclosure. The invention can be embodied in various forms and is not limited to the embodiments described herein.

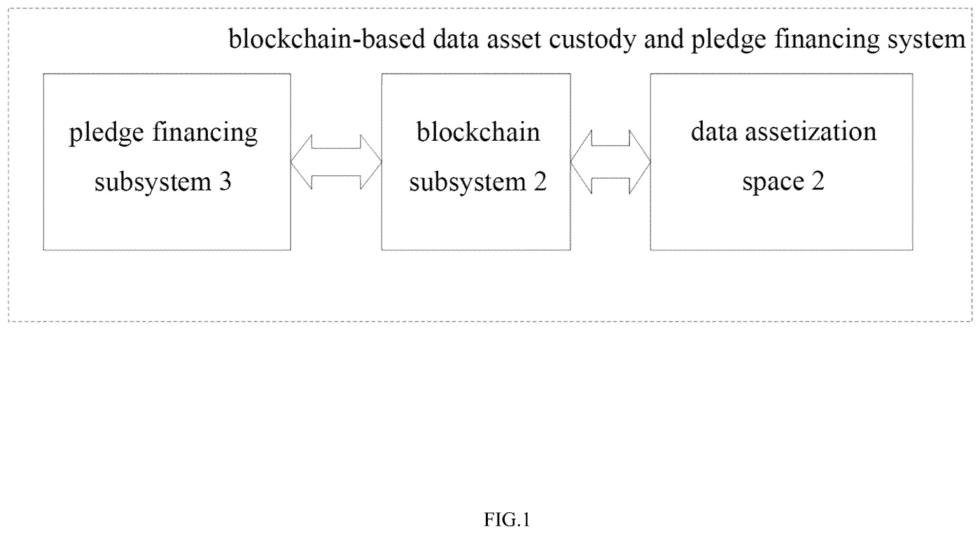

FIG. 1 shows a schematic block diagram of a blockchain-based data asset custody and pledge financing system, including:
a blockchain subsystem 1 used to provide full-process on-chain services for data resources, data products, and data asset circulation and transactions, along with query, management and control services; specifically, the blockchain subsystem 1 provides full-process on-chain services for data resources, data products, and data asset circulation and transactions, which enables all information about the transaction, circulation, and use of data resources, data products, and data assets to be recorded on the blockchain subsystem 1, ensuring the immutability and transparency of such information; the blockchain subsystem 1 provides query services that allow users to easily view the transaction history, source and usage of data, which helps build trust in the data and promotes its legitimate use; the blockchain subsystem 1 further provides data management and control services to ensure that data complies with relevant regulations and policies during circulation and use, which includes data access control, usage rights management, and data security protection;
a data assetization space 2 communicatively connected to the blockchain subsystem 1 for providing data assetization services and infrastructure, which is responsible for converting data into assets that can be traded and circulated, and provides the necessary support for data capitalization; and
a pledge financing subsystem 3 communicatively connected to the blockchain subsystem 1, which is used to provide services related to data asset pledge financing; specifically, the services can include: an asset account management service, a data asset pledge application service, a data asset pledge evaluation service, a data asset pledge credit service, a data asset certificate generation service, a data asset certificate pledge service, and a data asset pledge management and control service;

The system first conducts data assetization and data asset custody through the blockchain subsystem 1 and the data assetization space 2 to ensure the security and tradability of the data, and then carries out data asset pledge financing through the blockchain subsystem 1 and the pledge financing subsystem 3, so that the value of the data can be fully utilized, while also providing borrowers with a new way of financing.

Through full-process intelligent contract permission control and scheduling for data asset assetization, full-process measurable and traceable custody for data asset assetization, and full-link reliable evaluation and credit assessment for data asset pledge, the system ensures security control, authenticity, measurability, traceability, and oversight of data assets.

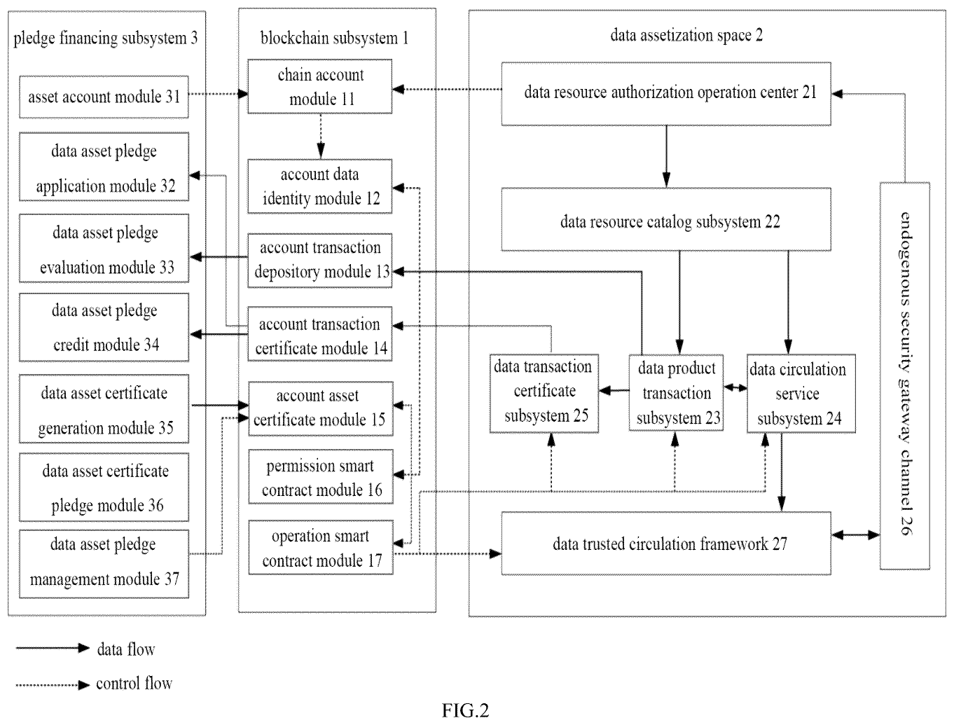

In order to better describe the specific structure of the blockchain-based data asset custody and pledge financing system, the explanation is now provided in conjunction with FIG. 2.

In one embodiment, the blockchain subsystem 1 of the present disclosure is used to provide full-process on-chain services for data resources, data products, and data asset circulation and transactions, along with query and control services. The specific structure of the blockchain subsystem 1 is described in conjunction with the following.

As shown in FIG. 2, the blockchain subsystem 1 includes:
a chain account module 11 used for maintaining a blockchain account, with functions that include operations such as account creation, management, querying, and updating to ensure that each data asset holder participating in the system has a unique blockchain account for security authentication and authorization;
an account data identity module 12 used for maintaining an account data identity corresponding to the blockchain account, to ensure that the data asset identity is verifiable and traceable, and to provide the necessary data support for the subsequent execution of the smart contract;
an account transaction depository module 13 used for recording the account transaction depository generated by the data assetization space 2, which provides tamper-proof evidence for the data asset transaction and ensures fairness, transparency, and legality of the transaction;
an account transaction certificate module 14 used for recording the blockchain data transaction certificate generated by the data assetization space 2, which provides legal certificate of the transaction for both parties to facilitate subsequent auditing, reimbursement or dispute resolution;
an account asset certificate module 15 used for recording data asset certificate generated by the pledge financing subsystem 3;
a permission smart contract module 16 used for deploying and executing corresponding permission smart contract based on the account data identity maintained by the account data identity module 12, where the smart contract defines the access and operation permissions of different accounts in the system, ensuring that only authorized users or organizations can perform specific operations, thereby safeguarding system security and data privacy, and the permission smart contract module deploys the account permissions and operational permissions for the data assetization service custody account associated with account data identity; and
an operation smart contract module 17 used for deploying and executing corresponding operation smart contract based on the account data identity maintained by the account data identity module 12. This smart contract defines specific operational rules, such as the flow and use of data assets in the system. It realizes the automation and transparency of data asset operations, reduces the risk of human intervention and misoperation, and improves the efficiency and reliability of the system.

In one embodiment, the data assetization space 2 of the present disclosure is communicatively connected to the blockchain subsystem 1 for providing data assetization services and infrastructure. The structure of the data assetization space 2 is now explained in detail in conjunction with the following content.

As shown in FIG. 2, the data assetization space 2 includes: a data resource authorization operation center 21, a data resource catalog subsystem 22, a data product transaction subsystem 23, a data circulation service subsystem 24, a data transaction certificate subsystem 25, an endogenous security gateway channel 26, and a data trusted circulation framework 27.

The endogenous security gateway channel 26 is mainly responsible for the transmission and safe delivery of data; the endogenous security gateway channel 26 is communicatively connected with the data resource authorization operation center 21 and is used to access data that needs to be circulated and traded to the data resource authorization operation center, ensuring the security and privacy of the data during transmission and preventing data leakage or unauthorized access. Preferably, the endogenous security gateway channel 26 applies mimetic endogenous security technology to achieve terminal security, access security, host security, platform security, data security, transaction security, application security, and security monitoring and management.

The data resource authorization operation center 21 plays a crucial role in the data assetization space 2, and is communicatively connected to the chain account module 11 of the blockchain, leveraging the characteristics of blockchain technology to achieve higher levels of data management and security.

The data resource authorization operation center 21 is used for blockchain identity management, data authorization operation, and data authorization custody. Regarding blockchain identity management, when users or organizations wish to participate in data transactions or data circulation, they first need to register to obtain a unique blockchain account, or log in and authenticate if they have already registered, and then the data resource authorization operation center 21 verifies the authenticity, legality, and validity of these identities through communication with the chain account module 11. This ensures that only authorized entities can access and manipulate data resources. Regarding data authorization operations, once the identity of a user or organization is verified, the data resource authorization operation center 21 will use blockchain-based smart contract technology to assign the corresponding data access and operation permissions to them. Regarding data authorization custody, it is the usage rights or operational rights of data assetization process that are authorized to the system for management and operation.

The data resource catalog subsystem 22 is communicatively connected to the data resource authorization operation center 21 and is used to manage data that needs to be circulated and traded after being authorized by the data resource authorization operation center 21.

The data product transaction subsystem 23 is communicatively connected to the data resource catalog subsystem 22 and the account transaction certificate module 14. The data product transaction subsystem 23 is used to perform a transaction operation of a data product through the deployed smart contract and record the entire transaction process on the blockchain through the smart contract. The transaction operations include: registration, compliance, listing, transaction, settlement, and delivery of a data product. Specifically, in the data product transaction subsystem 23, all transaction operations are automatically recorded on the blockchain through smart contracts, creating a tamper-proof transaction record. These records can be used as transaction evidence in the data provider's business system to prove the authenticity and legitimacy of the transactions

The data circulation service subsystem 24 is communicatively connected to the data resource catalog subsystem 22 and is used to share as well as circulate the data that needs to be circulated in the data resource catalog subsystem 22.

The data transaction certificate subsystem 25 is communicatively connected to the data product transaction subsystem 23 and is used to generate a blockchain data transaction certificate through the deployed smart contract in the blockchain subsystem 1 after the data product transaction in the data product transaction subsystem 23 is completed. Specifically, when the entire data transaction process in the data product transaction subsystem 23 is completed, the data provider's business system can automatically generate a blockchain data transaction certificate through the data transaction certificate subsystem 25 using smart contracts. This certificate can be used as the legal basis for data transactions to ensure their legality and validity.

The data circulation service subsystem 24 is communicatively connected to the data trusted circulation framework 27. The data trusted circulation framework 27 is further communicatively connected to the endogenous security gateway channel 26.

The data assetization space 2 also delivers data after completing the data product transaction through the data circulation service subsystem 24, the data trusted circulation framework 27, and the endogenous security gateway channel 26. Specifically, after the data product transaction is completed, the data provider's business system can ensure the security, reliability, and compliance of the data through the data circulation service subsystem 24, combined with the data trusted circulation framework 27 and the endogenous secure gateway channel 26, and deliver it to the data demander's business system. This process involves multiple stages, including data encryption, decryption, transmission, and verification, to ensure the integrity and security of the data. Preferably, the data trusted circulation framework 27 utilizes data cryptography and security techniques such as data encryption, multi-party security, federated learning, TEE privacy computing to achieve trusted data circulation.

In one embodiment, the pledge financing subsystem 3 is communicatively connected to the blockchain subsystem 1 for providing services related to data asset pledge financing. The detailed explanation is provided in conjunction with the following content.

As shown in FIG. 2, the pledge financing subsystem 3 includes: an asset account module 31, a data asset pledge application module 32, a data asset pledge evaluation module 33, a data asset pledge credit module 34, a data asset certificate generation module 35, a data asset certificate pledge module 36, and a data asset pledge management module 37.

The asset account module 31 is used for blockchain identity management. When users or organizations wish to participate in data pledge financing, they first need to register to obtain a unique blockchain account, or log in and authenticate if they are already registered.

The data asset pledge application module 32 is used to apply for the pledge of some or all of the selected data assets.

The data asset pledge evaluation module 33 is used to assist an evaluation agency to evaluate the selected data assets, based on the blockchain account transaction certificate data recorded in the account transaction depository module 13, where the evaluation agency can be a funding party, that is a financial institution or other investors directly involved in data transactions, or it can be an independent third-party evaluation agency with professional assessment capabilities and experience, capable of providing objective and impartial evaluation results. The evaluation includes: data asset identification, market value assessment, risk evaluation, etc.

The data asset pledge credit module 34 is used to assist a credit agency to query and verify the selected data assets, based on the blockchain account transaction certificates recorded in the account transaction certificate module 14, where the credit agency can be a funding party, that is a financial institution or other investors directly involved in data transactions, who need to conduct credit assessments of the data to ensure investment safety. The credit agency can also be an independent third-party credit agency, which possess professional credit reporting capabilities and experience, and can provide objective and impartial credit reporting services to funders or parties involved in data transactions.

The data asset certificate generation module 35 is used to generate a data asset certificate after the evaluation and verification have been completed, and record it in the account asset certificate module of the blockchain.

Data asset certificate pledge module 36 is used to pledge data asset certificates.

The data asset pledge management module 37 is used to perform a pledge control process based on a data asset certificate smart contract deployed in the blockchain subsystem 1.

Through the above blockchain-based data asset custody and pledge financing system, the data provider business system can perform data assetization, data asset custody, and data asset pledge financing. The detailed explanation is provided in conjunction with the following specific embodiments.

First, the requirements for data assetization include: controllability of data assetization, traceability of data assets, measurability of data asset value, and the provision of data assetization services and infrastructure by the data assetization space.

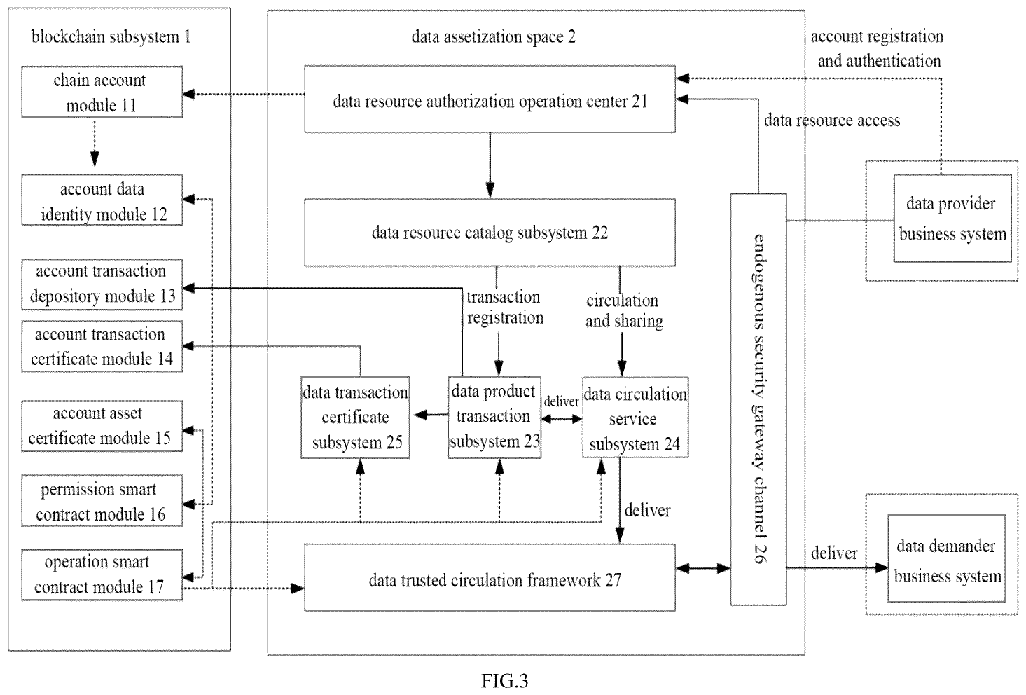

In one embodiment, as shown in FIG. 3, the method by which the data provider business system achieves data assetization through blockchain and data assetization space 2 includes:
a data provider business system performing a blockchain identity management through the data resource authorization operation center, where the blockchain identity management includes: one or more operations of blockchain account registration, login, and authentication; specifically, if the data provider is not registered, the data provider business system must first register through the data resource authorization operation center to obtain a unique blockchain account, and If already registered, the provider can directly log-in and authenticate; and
the data provider business system, which accesses the data required for circulation and transaction of data through the endogenous security gateway channel 26 to the data resource authorization operation center 21, for the purpose of classifying, categorizing, and authorizing the accessed data directory.

Specifically, the data catalog can be classified and categorized based on factors such as data sensitivity, importance, and usage, which typically involves categorizing data into different types (e.g., personal information, corporate data, industry data) and levels (e.g., public, internal, confidential). The purpose of categorization and classification is to better manage and control the access and use of data and to ensure data security and compliance in different scenarios. The data resource authorization operation center 21 automatically classifies the data catalog based on predefined classification criteria. At the same time, data can also be labeled with different levels based on its sensitivity and importance. This classification and grading information will form the basis for subsequent authorization management. after classifying and grading the data directory, the data provider business system performing authorization operation through the authorization operation center. This includes determining which users or organizations can access and use the data, as well as what actions they are permitted to perform, such as sharing or trading. The data resource authorization operation center 21 will record and manage all authorization information to ensure that only authorized users or organizations can access and use data. At the same time, it will also monitor data access and usage, promptly detecting and addressing any violations.

After being authorized to operate by the data resource authorization operation center 21, the data provider business system manages the data that needs to be circulated and traded through the data resource catalog subsystem 22, registers the data to be traded with the data product transaction subsystem 23 through the data resource catalog subsystem 22, and shares the data to be circulated through the data circulation service subsystem 24.

The data provider business system performs a data product transaction operation based on the configured smart contract through the data product transaction subsystem 23, uploads the whole process of transaction to the blockchain through the smart contract, generates an account transaction certificate for the data provider business system and records it in the account transaction depository module 13.

Specifically, the data provider business system configures a smart contract in the data product transaction subsystem 23, which involves defining key transaction-related terms such as transaction rules, conditions, pricing, payment methods, etc. The smart contract has corresponding execution conditions. After configuring and executing the smart contract, the data provider's business system can list the data products on the market within the data product transaction subsystem 23 for transaction operations. Trading operations include: registration, compliance, listing, trading, settlement, and delivery. Once the execution conditions are met (e.g., the data demander business system has paid the purchase amount), the smart contract will be automatically executed. This may include automatic fund transfer, updating ownership information for the data product, and triggering the data delivery process. And the execution results of the smart contract, including all details of the transaction, will be recorded on the blockchain subsystem 1. This step ensures transparency, immutability and traceability of transactions. At the same time, the transaction certificate of the data provider business system account will also be generated as an evidence of the completion of the transaction.

After completing the data product transaction in the data product transaction subsystem 23, the data provider business system generates a blockchain data transaction certificate based on the smart contract through the data transaction certificate subsystem 25;

Specifically, after the data provider business system completes the data product transaction in the data product transaction subsystem 23, the data provider business system 25 can automatically trigger the generation of a data transaction certificate based on the smart contract and record it in the account transaction certificate module 14.

After the data product transaction subsystem 23 completes the data product transaction, the data provider business system delivers data to the data demander business system through the data trusted circulation framework 21 and the endogenous security gateway channel 23.

Secondly, the data asset custody is the custody of the data assetization process, specifically the custody of data assetization services and infrastructure.

In one embodiment, the method for performing data asset custody by the data provider business system includes:
a data provider business system, performing a blockchain identity management through the data resource authorization operation center 21, where the blockchain identity management includes: one or more operations of blockchain account registration, login, and authentication; specifically, if the data provider is not registered, the data provider business system must first register through the data resource authorization operation center to obtain a unique blockchain account, and If already registered, the provider can directly log in and authenticate;
the data provider business system, performing data authorization operation and data authorization custody through the data resource authorization operation center 21, and registering the custody information to the corresponding blockchain account in the blockchain account module 11 and the corresponding account digital identity in the account data identity module 12 through the data resource authorization operation center 21 after authorization;
after completing the registration of the blockchain account and the account digital identity, the data provider business system simultaneously deploys the permission smart contract in the permission smart contract module 16 and the operation smart contract in the operation smart contract module 17 within the blockchain subsystem 1; and
further the data provider business system executes the deployed permission smart contract and operation smart contract, and executes the data assetization service custody account permissions and operational permissions through a sequence of the data product transaction subsystem 23, the data circulation service subsystem 24, the data transaction certificate subsystem 25 and the date trusted circulation framework 27.

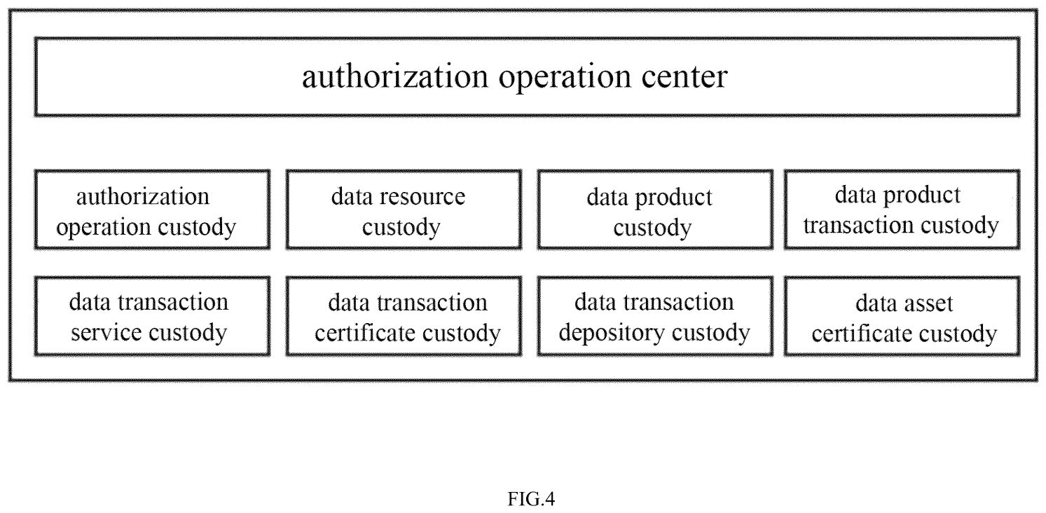

In one embodiment, as shown in FIG. 4, the types of data authorization custody include: authorization operation custody, data resource custody, data product custody, data product transaction custody, data transaction service custody, data transaction certificate custody, data transaction depository custody, and data asset certificate custody;

Specifically, the authorization operation custody involves the management and maintenance of the entire data operations process to ensure the efficient use and compliant operation of data assets. The data resource custody is the custody of original data resources, including data storage, backup, recovery and security protection to ensure the integrity and availability of data resources. The data product custody is the custody of data products. The data product custody involves the management and maintenance of data after processing, integration, and packaging into products, ensuring the quality and performance of the final product. The data transaction service custody provides intermediary services during the data transaction process to ensure fairness, transparency, and legality. This includes the authentication of the identities of the transaction parties, the examination and approval of the transaction conditions, and the supervision of the execution of the transaction. The data transaction certificate custody manages and stores the account transaction certificates generated during the transaction process. The data transaction depository custody manages and stores the depository of account transactions during the transaction process. The data asset certificate custody manages and stores the data asset certificate.

Finally, the data asset pledge financing involves a method for realizing data assetization. The method performs authority management and intelligent scheduling through data assetization, data assetization process custody, and smart contracts such as data asset certificates, achieving a full-chain credible assessment, credit evaluation, measurement, and control of data asset pledges. conducting data asset pledge financing after data assetization and data asset process custody.

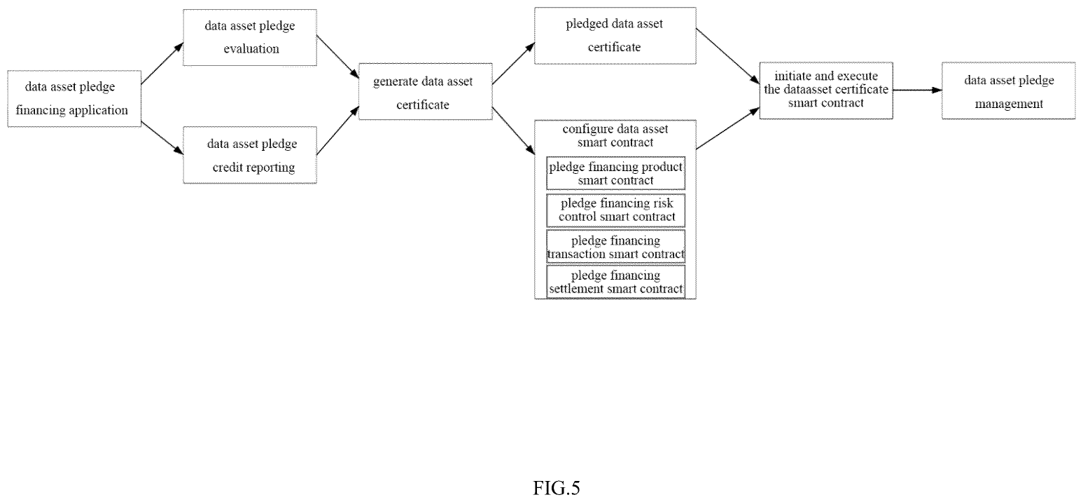

In one embodiment, as in FIG. 5, the method by which the data provider business system achieves data asset pledge financing through the blockchain and the pledge financing subsystem includes:
a data provider business system, performing one or more operations of blockchain account registration, login, and authentication through the asset account module 31; specifically, if the data provider is not registered, the data provider business system must first register through the asset account module 31 to obtain a unique blockchain account, and if already registered, the provider can directly log in and authenticate;
the data provider business system, querying the account transaction certificate of the corresponding account digital identity recorded in the blockchain subsystem 1 through the data asset pledge application module 32, selecting some or all of the data assets for pledge application, and automatically registering, with the permission smart contract, the information of the data asset pledge application of the account digital identity deployed in the blockchain subsystem 1, in order to verify the custody privileges of the corresponding custody account;
after passing the custody privilege verification, the evaluation agency evaluates the data assets selected by the data provider business system based on the transaction deposit data of the blockchain account through the data asset pledge evaluation module 33, so as to ensure the fairness and accuracy of the evaluation;
a credit agency, querying and verifying the data assets selected by the data provider business system, based on the transaction certificate of the blockchain account through the data asset pledge credit module;
after passing the evaluation and verification, the data provider business system generates a data asset certificate through the data asset certificate generation module 35 and records it to the account asset certificate module 15 of the blockchain subsystem 1;
after generating the data asset certificate, the data provider business system pledges the data asset certificate through the data asset certificate pledge module 36, and simultaneously deploys the data asset certificate smart contract in the corresponding operation smart contract on the blockchain; and
after completing the pledge of data asset certificate and the deployment of data asset certificate smart contract, the data provider business system automatically starts and executes the pledge control process for the corresponding data asset certificate smart contract through the data asset pledge management module 37.

In one embodiment, the data asset certificate smart contract includes:
a pledge financing product smart contract, for binding some or all of the data products selected by the data provider business system, the pledge financing product smart contract defines the scope, type, quantity, and other relevant attributes of the pledged data products; and the pledge financing product smart contract automatically executes to bind the selected data products as pledges and records them on the blockchain; the bound data products will be regulated by the smart contract to ensure that they are not altered or transferred at will during the pledge period;
a pledge financing risk control smart contract for the entire data assetization process, responsible for managing the smart contract control of data assetization, including risk identification, assessment, monitoring, and early warning; during the pledge financing process, the pledge financing risk control smart contract monitors the status of the data products, trading behavior, and market changes in real-time; if anomalies or potential risks are detected, the smart contract will trigger an alert mechanism, promptly notifying relevant parties and taking appropriate measures;
a pledge financing transaction smart contract for data resource authorization operation, data product full-process smart contract custody and security control, the pledge financing transaction smart contract ensures the legal authorization and operation of data resources in pledge financing transactions; it further provides full-process custody of the data product's transaction process, ensures transparency, fairness, and immutability of the transaction; in addition, the smart contract can provide security control of the transaction environment to prevent malicious attacks and illegal operations; and
a pledge financing settlement smart contract for configuring the settlement route of the data product settlement smart contract, the pledge financing settlement smart contract executes automatically according to the fund provider's configuration. At the end of the pledge financing, the pledge financing settlement smart contract will automatically calculate and handle the settlement of the pledged data products according to the preset settlement rules. The smart contract will automatically execute the settlement route according to the fund provider's configuration, ensuring that the funds reach the relevant parties in a timely and accurate manner. After the settlement is completed, the smart contract will update the status information on the blockchain to ensure the integrity and traceability of the data asset pledge financing process.

In summary, a blockchain-based data asset custody and pledge financing system are provided in the present disclosure, including a blockchain subsystem, a data assetization space, and a pledge financing subsystem. The system performs data assetization and data asset custody through the blockchain subsystem and the data assetization space, and then carries out data asset pledge financing through the blockchain subsystem and the pledge financing subsystem. Through full-process intelligent contract permission control and scheduling for data asset assetization, full-process measurable and traceable custody for data asset assetization, and full-link reliable evaluation and credit assessment for data asset pledge, the system ensures security control, authenticity, measurability, traceability, and oversight of data assets. This facilitates secure and efficient pledge financing of data assets, significantly reduces operating costs, meets customers' needs for efficient capital turnover, and provides effective financing services for core data enterprises. The present disclosure effectively addresses the limitations of existing technologies, making it highly valuable for industrial applications.

The embodiments described above serve merely as illustrative examples of the principles and effects of the present disclosure, and are not intended to serve as limitations on the invention. Persons skilled in the art may modify or alter these embodiments without departing from the spirit and scope of the present disclosure. Therefore, any equivalent modifications or alterations made by those skilled in the art, which are consistent with the spirit and technical concepts disclosed in the present disclosure, shall still fall within the scope of the claims of the present disclosure.

1. A system for blockchain-based data asset custody and pledge financing, comprising:
a blockchain subsystem, providing a full-process on-chain services for data resources, data products, and data asset circulation and transactions, along with query and control services;
a data assetization space, communicatively connected to the blockchain subsystem, wherein the data assetization space provides data assetization infrastructure and services; and
a pledge financing subsystem, communicatively connected to the blockchain subsystem, wherein the pledge financing subsystem provides services related to data asset pledge financing;
wherein the system performs data assetization and the data asset custody through the blockchain subsystem and the data assetization space, and carries out the data asset pledge financing through the blockchain subsystem and the pledge financing subsystem.

2. The system according to claim 1, wherein the blockchain subsystem comprises:
a chain account module for maintaining a blockchain account;
an account data identity module for maintaining an account data identity corresponding to the blockchain account;
an account transaction depository module for recording evidence of account transactions generated by the data assetization space;
an account transaction certificate module for recording blockchain data transaction certificates generated by the data assetization space;
an account asset certificate module for recording data asset certificates generated by the pledge financing subsystem;
a permission smart contract module for deploying and executing a corresponding permission smart contract based on the account data identity maintained by the account data identity module; and
an operation smart contract module for deploying and executing a corresponding operation smart contract based on the account data identity maintained by the account data identity module.

3. The system according to claim 2, wherein the data assetization space comprises: a data resource authorization operation center, a data resource catalog subsystem, a data product transaction subsystem, a data circulation service subsystem, a data transaction certificate subsystem, an endogenous security gateway channel, and a data trusted circulation framework;
wherein the endogenous security gateway channel accesses data that needs to be circulated and traded to the data resource authorization operation center;
wherein the data resource authorization operation center is communicatively connected with the chain account module for blockchain identity management, data authorization operation, and data authorization custody;
wherein the data resource catalog subsystem manages the data that needs to be circulated and traded after being authorized by the data resource authorization operation center;
wherein the data product transaction subsystem performs a transaction operation of a data product based on a configured smart contract, and upload the transaction operation to the blockchain through the configured smart contract;
wherein the data circulation service subsystem shares data that needs to be circulated in the data resource catalog subsystem;
wherein the data transaction certificate subsystem generates a blockchain data transaction certificate through the configured smart contract after the data product transaction subsystem completes a data product transaction; and
wherein the data assetization space further delivers data after completing the data product transaction through the data circulation service subsystem, the data trusted circulation framework, and the endogenous security gateway channel.

4. The system according to claim 3, further comprising:
a data provider business system, which performs a blockchain identity management through the data resource authorization operation center; wherein the blockchain identity management comprises: one or more operations of the blockchain account registration, login, and authentication;
wherein the data provider business system accesses data required for circulation and transaction through the endogenous security gateway channel to the data resource authorization operation center, for purpose of classifying, categorizing, and authorizing the accessed data directory;
wherein after being authorized by the data resource authorization operation center, the data provider business system manages data that needs to be circulated and traded through the data resource catalog subsystem, registers the data to be traded through the data resource catalog subsystem to the data product transaction subsystem, and shares the data to be circulated through the data circulation service subsystem;
wherein the data provider business system performs a data product transaction operation based on the configured smart contract through the data product transaction subsystem, uploads the transaction operation to the blockchain through the smart contract, and generating an account transaction certificate of the data provider business system;
wherein after the data product transaction subsystem completes the data product transaction operation, the data provider business system generates a blockchain data transaction certificate based on the smart contract through the data transaction certificate subsystem; and
wherein after the data product transaction subsystem completes the data product transaction operation, the data provider business system delivers data to a data demander business system through the data trusted circulation framework and the endogenous security gateway channel.

5. The system according to claim 3, further comprising:
a data provider business system, which performs a blockchain identity management through the data resource authorization operation center;
wherein the blockchain identity management comprises: one or more operations of the blockchain account registration, login, and authentication;
wherein the data provider business system performs data authorization operation and data authorization custody through the data resource authorization operation center, and registers custody information to the blockchain account and account digital identity in the blockchain subsystem through the data resource authorization operation center after authorization;
wherein after completing the registration of the blockchain account and the account digital identity, the data provider business system simultaneously deploys the permission smart contract and the operation smart contract in the blockchain subsystem; and
wherein after executing the deployed permission smart contract and operation smart contract, the data provider business system executes a data assetization service custody account permissions and operational permissions through the data product transaction subsystem, the data circulation service subsystem, the data transaction certificate subsystem and a date trusted circulation framework.

6. The system according to claim 5, wherein types of the data authorization custody comprise: authorization operation custody, data resource custody, data product custody, data product transaction custody, data transaction service custody, data transaction certificate custody, data transaction depository custody, and data asset certificate custody.

7. The system according to claim 5, wherein the pledge financing subsystem comprises: an asset account module, a data asset pledge application module, a data asset pledge evaluation module, a data asset pledge credit module, a data asset certificate generation module, a data asset certificate pledge module, and a data asset pledge management module;
wherein the asset account module performs blockchain identity management;
wherein the data asset pledge application module applies for pledge of some or all of selected data assets;
wherein the data asset pledge evaluation module assists an evaluation agency to evaluate the selected data assets based on blockchain account transaction record data stored in the blockchain subsystem;
wherein the data asset pledge credit module assists a credit agency to query and verify the selected data assets based on blockchain account transaction evidence recorded in the blockchain subsystem;
wherein the data asset certificate generation module generates a data asset certificate after evaluation and verification have been completed, and records the data asset certificate in the account asset certificate module of the blockchain;
wherein the data asset certificate pledge module pledges data asset certificates; and
wherein the data asset pledge management module performs a pledge control process based on a data asset certificate smart contract deployed in the blockchain subsystem.

8. The system according to claim 7,
wherein the data provider business system performs one or more operations of blockchain account registration, login, and authentication through the asset account module;
wherein the data provider business system queries the account transaction certificate of the corresponding account digital identity recorded in the blockchain subsystem through the data asset pledge application module, selects some or all of the selected data assets for pledge application, and automatically registers information of the data asset pledge application with the permission smart contract of the account digital identity deployed in the blockchain subsystem for verifying the custody privileges of the corresponding blockchain account;
wherein after passing the custody privilege verification, the evaluation agency evaluates the data assets selected by the data provider business system based on transaction deposit data of the blockchain account through the data asset pledge evaluation module;
wherein the credit agency queries and verifies the data assets selected by the data provider business system based on the transaction certificate of the blockchain account through the data asset pledge credit module;
wherein after passing the evaluation and verification, the data provider business system generates a data asset certificate through the data asset certificate generation module and records it to the account asset certificate module of the blockchain subsystem;
wherein after generating the data asset certificate, the data provider business system pledges the data asset certificate through the data asset certificate pledge module, and simultaneously deploys the data asset certificate smart contract in the corresponding operation smart contract on the blockchain subsystem; and
wherein after completing the pledge of data asset certificate and the deployment of data asset certificate smart contract, the data provider business system automatically starts and executes the pledge control process for the corresponding data asset certificate smart contract through the data asset pledge management module.

9. The system according to claim 8, wherein the data asset certificate smart contract comprises:
a pledge financing product smart contract for binding some or all of the data products selected by the data provider business system;
a pledge financing risk control smart contract for managing and controlling the smart contract of the data assetization space;
a pledge financing transaction smart contract for data resource authorization operation, full-process smart contract custody of data products and security control; and
a pledge financing settlement smart contract for configuring a settlement route of the data product settlement smart contract, wherein the pledge financing settlement smart contract executes automatically according to a fund provider's configuration.

10. The system according to claim 3, wherein the data trusted circulation framework applies data encryption and security technologies for communication.
